(19) United States
(12) Patent Application Publication
(10) Pub. No.: US 2014/0198845 A1
(43) Pub. Date: Jul. 17, 2014

(54) Video Compression Technique

(71) Applicants: Hari Kalva, Delray Beach, FL (US); Velibor Adzic, Boca Raton, FL (US)

(72) Inventors: Hari Kalva, Delray Beach, FL (US); Velibor Adzic, Boca Raton, FL (US)

(73) Assignee: Florida Atlantic University, Boca Raton, FL (US)

(21) Appl. No.: 14/151,812

(22) Filed: Jan. 10, 2014

Related U.S. Application Data
(60) Provisional application No. 61/848,729, filed on Jan. 10, 2013.

(51) Int. Cl. H04N 19/85; H04N 19/20

(52) U.S. Cl. CPC H04N 19/00903; H04N 19/00387
USPC 375/240.08; 375/240.26

(57) ABSTRACT

A method for producing compressed video signals representative of a sequence of video frames, including the following steps: determining the value of a temporal variation parameter between successive frames, or portions thereof, of the sequence of frames; determining when the temporal variation parameter meets a predetermined criterion and indexing the frame transitions where the criterion is met; and digitally encoding the sequence of frames with relative reduction of the bitrate for at least a portion of the earlier-occurring frame of each indexed transition.

### PRIORITY CLAIM

Priority is claimed from U.S. Provisional Patent Application No. 61/848,729, filed Jan. 10, 2013, and said Provisional Patent Application is incorporated herein by reference.

### FIELD OF THE INVENTION

This invention relates to the field of video compression and, more particularly, to video compression that exploits characteristics of the human visual system.

### BACKGROUND OF THE INVENTION

Modern video compression algorithms rely in some part on characteristics of the human visual system (HVS). However, there are a number of findings in psycho-visual studies that haven't been explored in the context of video compression applications. One such finding is the phenomenon of temporal visual masking. Visual masking in the temporal and spatial domains was discovered by psychologists more than a century ago. (See, for example, C. S. Sherrington, “On The Reciprocal Action In The Retina As Studied By Means Of Some Rotating Discs,” J. Physiology 21, 1897, p. 33-54; W. McDougall, “The Sensations Excited By A Single Momentary Stimulation Of The Eye,” Brit. J. Psychol 1, 1904, p. 78-113.) It occurs when the visibility of a target stimulus is reduced by the presence of mask stimulus. Backward temporal masking is manifested at significant changes between frames; that is, the new frame masks a certain portion of previous frames. A number of frames that precede the significant change are essentially erased from higher levels of processing in the HVS. A subject is unable to consciously perceive certain portions of these frames. The position in a video where such a change in the visibility of portions of frames is affected is referred to as a transition.

Although the scientific community doesn't have clear explanation for this phenomenon, one of the promising explanations for backward masking is the variation in the latency of the neural signals in the visual system as a function of their intensity (see A. J. Ahumada Jr., B. L. Beard and R. Eriksson, “Spatio-Temporal Discrimination Model Predicts Temporal Masking Function,” Proc. SPIE Human Vision and Electronic Imaging, vol. 3299, 1998, pp. 120-127). An overview of models and findings in visual backward masking can be found in A. J. Ahumada Jr., B. L. Beard and R. Eriksson, “Spatio-Temporal Discrimination Model Predicts Temporal Masking Function,” Proc. SPIE Human Vision and Electronic Imaging, vol. 3299, 1998, pp. 120-127.

It is among the objectives hereof to exploit transitions for video compression.

### SUMMARY OF THE INVENTION

Although a significant amount of research related to visual masking and signal processing has been done in the past, it is mostly focused on spatial masking for image compression (see A. N. Netravali and B. Prasada, “Adaptive Quantization Of Picture Signals Using Spatial Masking,” Proceedings of the IEEE, vol. 65, no. 4, pp. 536-548, April 1977; M. Naccari and F. Pereira, “Comparing Spatial Masking Modelling In Just Noticeable Distortion Controlled H.264/AVC Video Coding,” 11th International Workshop on Image Analysis for Multimedia Interactive Services, 2010). As far as temporal masking is concerned, a paper by Girod (see B. Girod, “The Information Theoretical Significance Of Spatial And Temporal Masking In Video Signals,” Proc. SPIE Human Vision, Visual Processing and Digital Display, vol. 1077, 1989, pp. 178-187) explores forward masking—showing that there is some form of masking effect immediately after a scene change. Tam et al. (see W. J. Tam, L. B. Stelmach, L. Wang, D. Lauzon and P. Gray, “Visual Masking At Video Scene Cuts,” Proc. SPIE Human Vision, Visual Processing and Digital Display, vol. 2411, 1995, pp. 111-119) investigated the visibility of MPEG-2 coding artifacts after a scene cut and found significant visual masking effects only in the first subsequent frame. Carney et al. (Q. Hu, S. A. Klein and T. Carney, “Masking Of High-Spatial-Frequency Information After A Scene Cut,” Society for Informational Display 93 Digest. n. 24, 1993, p. 521-523) investigated levels of sensitivity of HVS to blur in the first 100-200 milliseconds after a scene cut.

Pastrana-Vidal et al. (R. R. Pastrana-Vidal, J.-C. Gicquel, C. Colomes and H. Cherifi, “Temporal Masking Effect On Dropped Frames At Video Scene Cuts,” Proc. SPIE Human Vision and Electronic Imaging IX, vol. 5292, 2004, pp. 194-201) studied the presence of backward and forward temporal masking based on visibility threshold experiments using video material in common intermediate format (CIF) resolution (352×288 pixels). They simulated a single burst of dropped frames near a scene change, for different impairment durations from 0 to 200 ms. The transitory reduction of the HVS sensibility was reported to be significant in the first 160 ms for forward masking and up to 200 ms for backward masking. A study by Huynh-Thu and Ghanbari (Q. Huynh-Thu and M. Ghanbari, “Asymmetrical Temporal Masking Near Video Scene Change,” ICIP 2008 15th IEEE International Conference On Image Processing, vol., no., pp. 2568-2571) also showed that backward masking is more significant than forward masking. They used a burst of frozen frames as stimulus and scene cut as mask.

In accordance with a form of the invention, a method is set forth for producing compressed video signals representative of a sequence of video frames, including the following steps: determining the value of a temporal variation parameter between successive frames, or portions thereof, of the sequence of frames; determining when said temporal variation parameter meets a predetermined criterion and indexing the frame transitions where said criterion is met; and digitally encoding said sequence of frames with relative reduction of the bitrate for at least a portion of the earlier-occurring frame of each indexed transition.

In an embodiment of the invention, the step of determining a temporal variation parameter comprises determining contrast changes between frames or portions thereof. In this embodiment, said determining of contrast changes comprises determining the average intensity level of the luminosity component in at least a portion of each of the frames.

In a further embodiment of the invention, the step of determining a temporal variation parameter comprises determining motion changes between frames or portions thereof. In this embodiment, said determining of motion changes comprises determining the average motion activity level, coherence, and orientation of motion in at least a portion of each of the frames. In another embodiment of the invention, the step of determining a temporal variation parameter comprises weighting a temporal variation parameter with frame content information, for example, the number of objects in the frame or portions thereof.

In a still further embodiment of the invention, the step of determining a temporal variation parameter comprises determining texture changes between frames or portions thereof. This can be implemented by determining the contribution of different frequency bands in at least a portion of each of the frames.

In a preferred embodiment of the invention, the digital encoding of the sequence of frames includes quantizing pixel values of the frames of the sequence, and the digital encoding of said at least a portion of the earlier-occurring frame of each indexed transition comprises using fewer bits (lower frame quality) than are used in standard video encoding methods. This can comprise increasing the quantization parameter.

In an embodiment of the invention, the encoding step includes encoding said sequence of frames with relative reduction of the bit rate for at least a portion of a frame preceding the earlier-occurring frame of each indexed frame. In another embodiment the encoding step includes encoding said sequence of frames with relative reduction of the bit rate for at least a portion of a plurality of frames preceding the earlier-occurring frame of each indexed frame.

Further features and advantages of the invention will become more readily apparent from the following detailed description when taken in conjunction with the accompanying drawings.

### BRIEF DESCRIPTION OF THE DRAWINGS

FIG. 1 is a schematic block diagram of a type of network in which embodiments of the invention can be employed.

FIG. 2 is a simplified diagram showing operation of a form of the invention.

FIG. 3 is a flow diagram of a routine for controlling a processor to perform steps in accordance with a portion of an embodiment of the invention, relating to determination of transitions of a temporal parameter used to identify perceptually less important frames of a sequence of video frames.

FIG. 4 is flow diagram of a routine for controlling a processor, in accordance with a portion of an embodiment of the invention, relating to encoding perceptually less important frames at a reduced bitrate.

FIG. 5 is a diagram showing identification of a portion of successive video frames which can be compared in determining a temporal variation parameter.

FIG. 6 is a diagram illustrating the process flow used to obtain data for experiments relating to the invention.

FIG. 7 is a Table showing the bitrate savings for the experimental methods compared to a baseline.

FIGS. 8A and 8B are block diagrams illustrating server and network node applications of embodiments of the invention.

### DETAILED DESCRIPTION

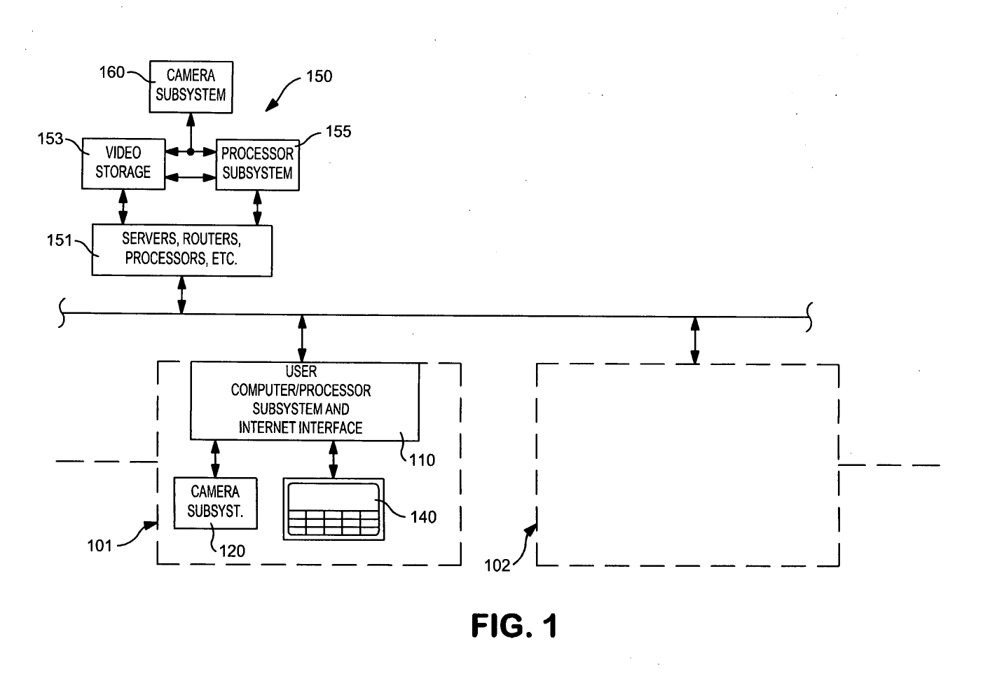

FIG. 1 is a simplified block diagram showing a wired or wireless internet link or network that includes a content provider station 150 and a multiplicity of user stations 101, 102, . . . , which may typically comprise, for example, cellphones, personal digital assistants (PDAs) or conventional computer stations. Each user station typically, includes inter alia, a user computer/processor subsystem and an internet interface, collectively represented by block 110, with an associated tablet 140 for display and keyboard/pointer functions. It will be understood that conventional memory, input/output, and other peripherals will typically also be included, and are not separately shown in conjunction with each processor. A camera function is also typically provided.

The provider station 150 of this example includes processors, servers, and routers as represented at 151. Also shown, at the site, but which can be remote therefrom, is processor subsystem 155, which, in the present embodiment is, for example, a digital processor subsystem which, when programmed consistent with the teachings hereof, can be used in implementing embodiments of the invention. It will be understood that any suitable type of processor subsystem can be employed, and that, if desired, the processor subsystem can, for example, be shared with other functions at the station. The station 150 also includes video storage 153, and other suitable sources of video signals, including camera subsystem 160.

It will be understood that the FIG. 1 system is a non-limiting example of an application in which the invention can be employed, such as for bandwidth compression, and that other applications thereof will be evident. For example, any sequence of video frames can be encoded in accordance with embodiments hereof and stored for short or long term retrieval, thereby saving substantial storage space.

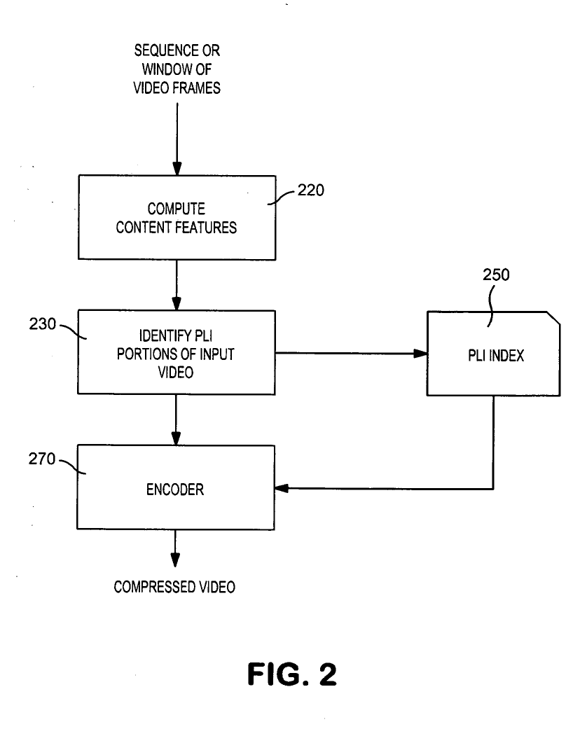

FIG. 2 shows a simplified flow diagram of a procedure for identifying and indexing frames of a window or sequence of video frames that are perceptually less important (“PLI”) than other frames of the sequence (or window) of frames. The block 220 represents the computation of characteristic features of frames or portions of frames, as will be described further, in order to determine temporal variation parameters. Then, the perceptually less important (PLI) portions of input video are identified (block 230), and the PLI frames are indexed (block 250). The block 270 represents the encoding function which utilizes the PLI index to identify frames with respect to which bitrate reduction is implemented in accordance with embodiments of the invention.

There are a number of characteristic features or parameters that can be used in determining temporal variation which can give rise to opportunities for bitrate reduction.

In one preferred embodiment hereof, contrast changes between frames are computed. In a described embodiment, contrast is measured by calculating the average intensity level of the luminosity component (Y channel). It can be calculated either in the pixel or transform domain. In the pixel domain, as in the example hereinbelow, it is an arithmetic average of all pixel values (between, say, 0 and 255). In the transform domain it can be calculated as an arithmetic average of the DC component magnitude(s).

In another embodiment, content changes can be computed. Objects can be identified inside regions (i.e. faces, persons, trees, . . . ), enumerated, and annotated. The number of objects and the percentage of occupied area are encoded for each region. This object information can used to adjust the weight of temporal variation parameters computed for those frames.

In another embodiment, motion can be computed. Activity in regions can be calculated from compressed domain information, primarily using motion vectors. For example, the computation can utilize an arithmetic average of motion vector magnitudes with additional information on quantized orientation. Orientation can be represented, for example, as one of eight orientations, each separated by 45 degree angles.

In another embodiment, texture changes can be computed. This characteristic can be calculated in the frequency domain and is a measure of contribution of different frequency bands. It can be represented by separate bands or as a weighted average.

In another embodiment, emotion evoked by content can be utilized. High level information can be related to emotional and other states either inferred by the author of the content, extracted from subjective studies, or derived from content-based models for emotion computation. Different states can be used to label frames or groups of frames. These labels can be present in the stream as metadata and can be signaled for each frame.

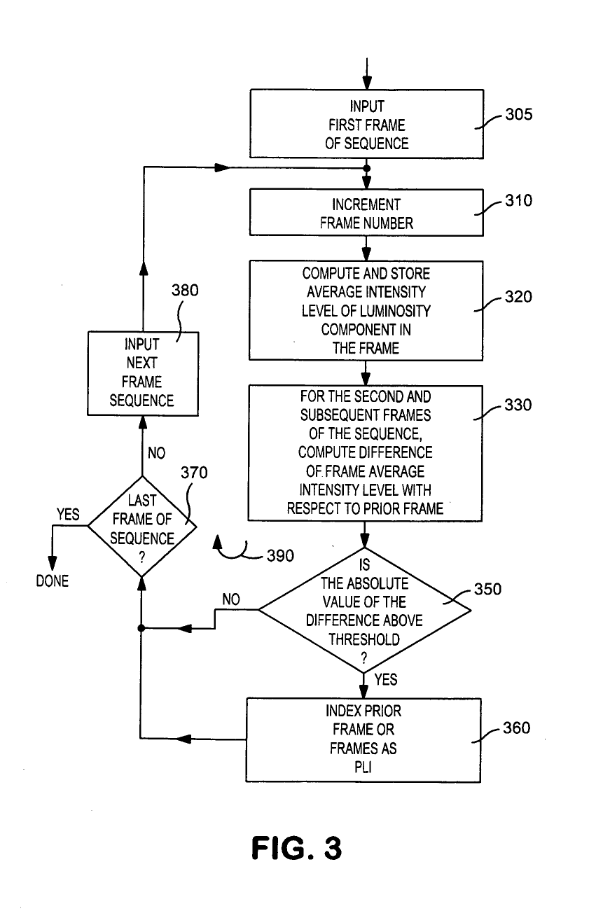

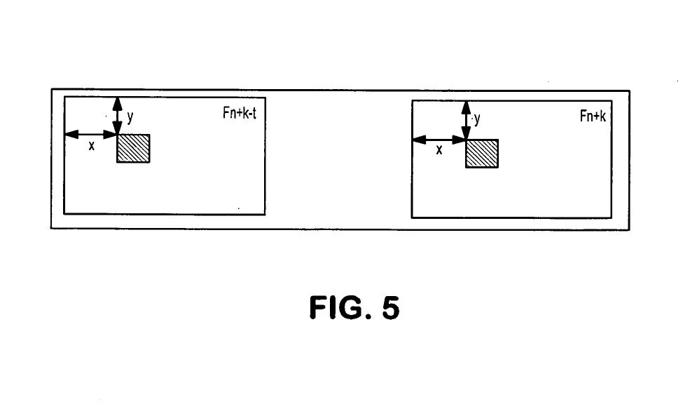

Referring to FIG. 3, there is shown a flow diagram of a routine for controlling a processor (such as a processor subsystem 155 of FIG. 1) to implement the indexing of perceptually less important (“PLI”) frames in accordance with an embodiment of the invention. The block 305 represents the inputting of the first frame of a window or sequence of video representative frames and the initialization of a frame count for this sequence. The block 310 represents the incrementing of the counter for the frame number, and the block 320 represents the computing and storing of the average intensity level of luminosity components in the current frame. For example, this can be the value of Y for each pixel of the frame. Alternatively, in embodiments hereof, a portion or portions of the frame can be utilized for this purpose. As an example, and as seen in FIG. 5, a region defined by the (x, y) coordinate of the corner of the block of a defined area can be specified. The FIG. 5 shows two frames designated Fn+k−t and Fn+k, where the variable t is the temporal distance between frames. The indicated region R (x, y) can comprise the whole frame or a region within the frame. Analysis can be performed on a subset of frames in the sequence or window, and is not limited to two consecutive frames.

Referring again to FIG. 3, the block 330 represents the computation, for the second and subsequent frames of the sequence, of the difference of the computed average intensity level of luminosity from the value determined for the prior frame. A determination is then made (decision block 350) as to whether the absolute value of the difference is above a predetermined threshold value. If so, as represented by block 360, the prior frame or frames (that is, the earlier-occurring frame of the just-detected transition), is indexed as a PLI (perceptually less important) frame. The decision block 370 is then entered for determination of whether the last frame of the sequence has been reached. (The block 370 is also entered directly if the inquiry of decision block 350 did not result in the determination of the defined transition.) If the last frame of the sequence being processed has been reached, the routine is completed for this sequence of frames. If not, the block 380 is entered, this block representing the inputting of the next frame of the sequence. The loop 390 continues until all frames of the sequence have been processed and the PLI frames thereof have been indexed. It will be understood that the block 320 can be utilized to determine other temporal variation parameters, for example those previously enumerated.

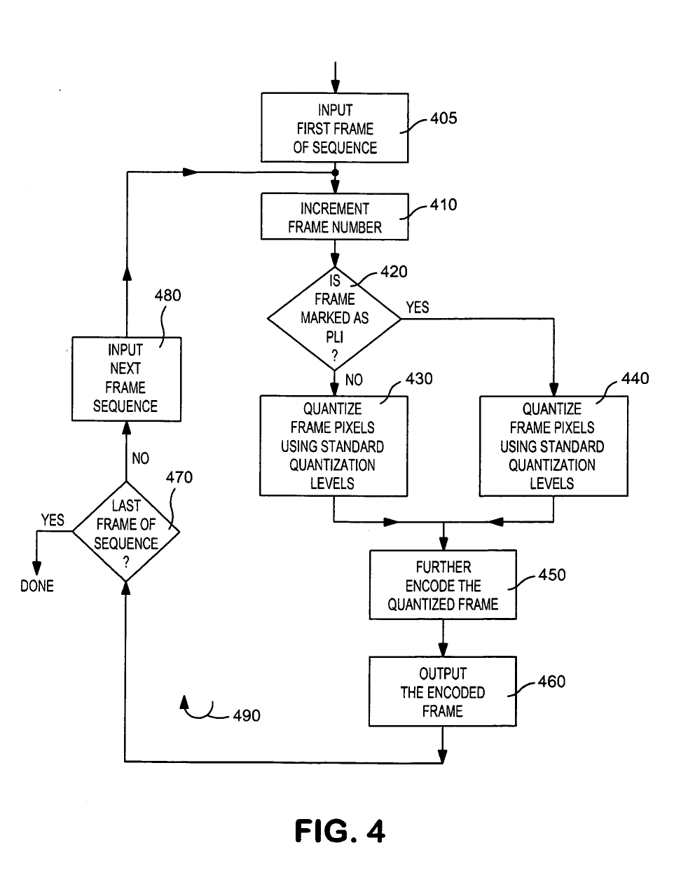

Referring to FIG. 4, there is shown a flow diagram of a routine for controlling the processor to encode the sequence of frames, with the PLI frames, or portions thereof, being encoded at reduced bit rates, in accordance with an embodiment of the invention. The block 405 represents the inputting of the first frame of the sequence of video frames and the initialization of the frame count for this sequence. The block 410 represents the incrementing of the counter for the frame number. Inquiry is then made (decision block 420) as to whether the current frame is indexed as perceptually less important (PLI). If not, the block 430 is entered, and quantization is performed on the frame, or portion thereof, using a regular number of quantization levels (or bits) for the particular application. If, however, the frame is indexed as a PLI frame, quantization is implemented with a relatively reduced number of quantization levels (or bits) as compared to the standard number of bits for the present application. It will be understood that other known compression techniques (including, but not limited to, predictive coding and/or entropy coding), for frames of the sequence or portions thereof, can be utilized in conjunction with the advantageous compression based on reduced bitrate for PLI frames as described in this example. Also, it will be understood that the reduced bitrate encoding for the PLI frames or portions thereof, can be implemented by reducing the bitrate for these other aspects of the overall encoding process.

Referring again to FIG. 4, after the quantization, the encoded frames, or portions thereof, can be further encoded (as represented by block 450, in the manner just indicated), and can be output, as represented by the block 460 of this routine. Inquiry is then made (decision block 470) as to whether the last frame the sequence of frames has been reached. If not, the next frame of the sequence is input (block 480), and the loop 490 continues until all frames of the sequence have been encoded.

Instead of coding PLI frames with lower quality, a video system can signal the frames as perceptually redundant while compressing them as normal frames. This information about frames can, for example, be signaled in the header information present in the video layer or network transport layer. For example, a NAL packet header in H.264 or RTP header can include such information. A video server can skip sending PLI frames in order to reduce bitrate. A network node can drop such PLI frames with minimal or no effects on user experience.

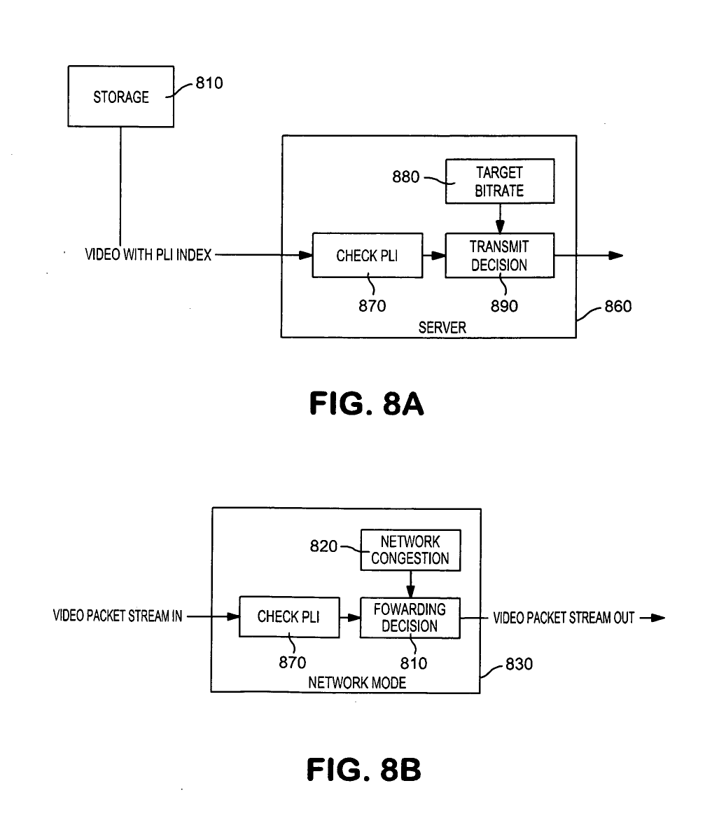

FIGS. 8A and 8B illustrate how video bitstreams, in which the PLI index has been packetized, can be used in a network (such as the FIG. 1 network) to judiciously reduce the bitrate of video transmitted on the network. In FIG. 8A, video with the PLI index (e.g. PLI index obtained using the routine of FIG. 3 and inserted in the packets of video) is stored in storage 810, and coupled with server 860. The frames of video are checked for PLI index (block 870) and, depending on the target bitrate (block 880), a transmit decision (block 890) can remove or reduce the bitrate of frames to be transmitted. In the network node 830 of FIG. 8B, a video packet stream again contains the PLI index, which is checked (block 870). In this case, an indicator of network congestion (block 820) controls a forwarding decision (block 810) determinative of whether ultimate reduction of bitrate for PLI frames will be necessary.

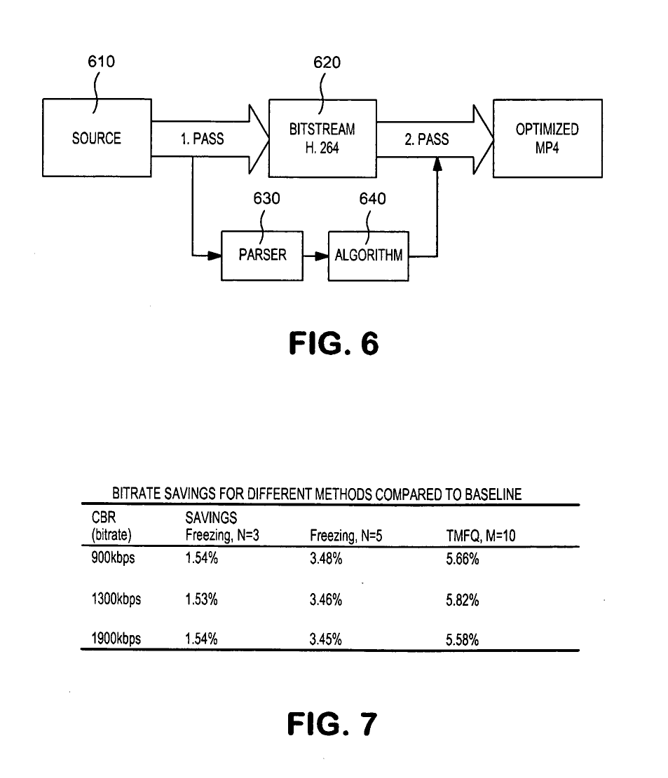

Experiments were directed toward studying how bitrate can be saved by introducing distortions or impairments in the frames just before scene change. Both frame dropping (freezing) and modification of quantization were tested. The experiments were conducted with frame sequences obtained using process flow as shown in FIG. 6. FIG. 6 shows the source 610, the first pass to obtain the H264 bitstream (620) with the identified scene change transitions, and second pass to obtain optimized MP4 having the reduced bitrate PLI frames, with the parser and algorithm being represented at 630 and 640, respectively. The source dataset contained twenty video sequences with standard definition resolution (SD, 720×480p) obtained from DVD sources. Videos are 30 second long clips from popular features and animated movies and music videos—in general, content that is very popular and generates much of the traffic on the internet. All videos were presented at 25 frames per second (fps) on 20 inch monitors, in the setting that complies with ITU-R recommendation BT.500-11. Subjects were five students with normal or corrected-to-normal vision.

Freezing was implemented by repeating a last selected frame until the scene change. An aggressive quantization algorithm was implemented by raising quantizing parameter (QP) for the selection of frames before scene change. (A higher QP uses less bits). Temporally masked frame quantization (TMFQ) was implemented by raising quantizing parameter (QP) for target window of M frames immediately before a scene change. The last couple of frames were quantized with maximal QP allowed in H.264 encoder. For the rest of the preceding frames a sigmoid-like ramp was used that gracefully lowered QP increase.

A first set of experiments showed that freezing can be applied with limited success for frames in the range of 100-200 ms before scene change. In order to obtain perceptually lossless optimization, freezing was applied to at most two frames (with 25 fps, that's 80 milliseconds).

For a second set of experiments perceptually lossless optimization was targeted using aggressive quantization. This involved finding the limit at which there are 0% of reported distortions. This was achieved for up to ten frames before scene cut, using the ramp described earlier. Not only did quantization allow for additional distortions in more frames than freezing, it also yielded more savings in bitrate for the same number of frames compared to freezing. This confirms a hypothesis for better results with aggressive quantization. The achieved savings are shown in the Table of FIG. 7. Savings are calculated compared to constant bitrate H.264 coding (CBR). CBR was benchmarked as a baseline because it is used in platforms such as adaptive streaming which are reported to contribute the most to video traffic on the internet. The indicated savings can be significant, having in mind the volume of traffic generated by video streaming. Also, coupling temporal masking and motion visual masking can provide further substantial bitrate savings, depending on content.

The technique hereof can be implemented in live video scenarios where short delay is permitted (as well, of course, where storage is involved for later use). The only information that is needed in advance is the position of scene change. This can have significant impact on bandwidth savings, especially bearing in mind predictions that show a trend of growing video content-related traffic on the internet.

1. A method for producing compressed video signals representative of a sequence of video frames, comprising the steps of:
determining the value of a temporal variation parameter between successive frames, or portions thereof, of the sequence of frames;
determining when said temporal variation parameter meets a predetermined criterion and indexing the frame transitions where said criterion is met; and
digitally encoding said sequence of frames with relative reduction of the bitrate for at least a portion of the earlier-occurring frame of each indexed transition.

2. The method as defined by claim 1, wherein said step of determining a temporal variation parameter comprises determining contrast changes between frames or portions thereof.

3. The method as defined by claim 2, wherein said determining of contrast changes comprises determining the average intensity level of the luminosity component in at least a portion of each of the frames.

4. The method as defined by claim 1, wherein said step of determining a temporal variation parameter comprises determining motion changes between frames or portions thereof.

5. The method as defined by claim 1, wherein said step of determining a temporal variation parameter comprises determining content changes between frames or portions thereof.

6. The method as defined by claim 1, wherein said step of determining a temporal variation parameter comprises determining texture changes between frames or portions thereof.

7. The method as defined by claim 6, wherein said determining of texture changes comprises determining the contribution of different frequency bands in at least a portion of each of the frames.

8. The method as defined by claim 1, wherein said digital encoding of said sequence of frames includes quantizing pixel values of the frames of said sequence, and wherein the digital encoding of said at least a portion of the earlier-occurring frame of each indexed transition comprises quantizing the pixel values of said at least a portion of said earlier-occurring frame of each indexed transition using fewer quantization levels than are used for quantizing pixels of other frames of the sequence which are not earlier-occurring frames of indexed transitions.

9. The method as defined by claim 3, wherein said digital encoding of said sequence of frames includes quantizing pixel values of the frames of said sequence, and wherein the digital encoding of said at least a portion of the earlier-occurring frame of each indexed transition comprises quantizing the pixel values of said at least a portion of said earlier-occurring frame of each indexed transition using fewer quantization levels than are used for quantizing pixels of other frames of the sequence which are not earlier-occurring frames of indexed transitions.

10. The method as defined by claim 1, wherein said encoding step includes encoding said sequence of frames with relative reduction of the bit rate for at least a portion of a frame preceding the earlier-occurring frame of each indexed frame.

11. The method as defined by claim 1, wherein said encoding step includes encoding said sequence of frames with relative reduction of the bit rate for at least a portion of a plurality of frames preceding the earlier-occurring frame of each indexed frame.

12. The method as defined by claim 1, further comprising packetizing said sequence of video frames in conjunction with the indexed frame transitions.

13. The method as defined by claim 12, wherein said step of digital encoding includes implementing said relative reduction of bitrate depending on a target bitrate.

14. The method as defined by claim 12, wherein said step of digital encoding includes implementing said relative reduction of bitrate depending on the extent of congestion in a network on which the digitally encoded sequence of frames is to be applied.

15. A method for producing compressed video signals representative of a sequence of video frames, comprising the steps of:
determining the value of a temporal variation parameter between successive frames of the sequence of frames;
determining when said temporal variation parameter meets a predetermined criterion and indexing the frame transitions where said criterion is met; and
digitally encoding said sequence of frames with relative reduction of the bitrate for the earlier-occurring frame of each indexed transition.

16. The method as defined by claim 15, wherein said step of determining a temporal variation parameter comprises determining contrast changes between frames.

17. The method as defined by claim 16, wherein said determining of contrast changes comprises determining the average intensity level of the luminosity component in each of the frames

18. The method as defined by claim 15, wherein said step of determining a temporal variation parameter comprises determining motion changes between frames.

19. The method as defined by claim 15, wherein said step of determining a temporal variation parameter comprises determining content changes between frames.

20. The method as defined by claim 15, wherein said step of determining a temporal variation parameter comprises determining texture changes between frames.

21. The method as defined by claim 20, wherein said determining of texture changes comprises determining the contribution of different frequency bands in each of the frames.

22. The method as defined by claim 15, wherein said digital encoding of said sequence of frames includes quantizing pixel values of the frames of said sequence, and wherein the digital encoding of said earlier-occurring frame of each indexed transition comprises quantizing the pixel values of said earlier-occurring frame of each indexed transition using fewer quantization levels than are used for quantizing pixels of other frames of the sequence which are not earlier-occurring frames of indexed transitions.

23. The method as defined by claim 15, wherein said encoding step includes encoding said sequence of frames with relative reduction of the bit rate for a frame preceding the earlier-occurring frame of each indexed frame.

24. The method as defined by claim 15, wherein said encoding step includes encoding said sequence of frames with relative reduction of the bit rate for a plurality of frames preceding the earlier-occurring frame of each indexed frame.

25. A method for producing compressed video signals representative of a sequence of video frames, comprising the steps of:
determining the value of a temporal variation parameter between successive frames, or portions thereof, of the sequence of frames;
determining when said temporal variation parameter meets a predetermined criterion and indexing the frame transitions where said criterion is met; and
digitally encoding and transmitting said sequence of frames with removal of at least the earlier-occurring frame of each indexed transition.

26. The method as defined by claim 25, wherein said removal of at least the earlier occurring frame of each indexed transition comprises removal of said earlier-occurring frame and at least the frame preceding said earlier-occurring frame.

27. The method as defined by claim 25, further comprising packetizing said sequence of video frames in conjunction with the indexed frame transitions.

28. The method as defined by claim 25, wherein said step of removal of at least said earlier-occurring frame depends on the extent of congestion in a network on which the digitally encoded sequence of frames is to be transmitted.
